(19) United States
(12) Patent Application Publication
(10) Pub. No.: US 2012/0068898 A1
(43) Pub. Date: Mar. 22, 2012

(54) COMPACT ULTRA WIDE BAND ANTENNA FOR TRANSMISSION AND RECEPTION OF RADIO WAVES

(75) Inventors: Nathan Clow, Salisbury (GB); Ivor Leslie Morrow, Swindon (DE)

(73) Assignee: THE SECRETARY OF STATE FOR DEFENCE, SALISBURY WILTSHIRE (GB)

(21) Appl. No.: 13/375,234

(22) PCT Filed: Jun. 8, 2010
(86) PCT No.: PCT/GB10/01129

§ 371 Date: Nov. 30, 2011

(30) Foreign Application Priority Data
Jun. 9, 2009 (GB) 0909878.1
Oct. 9, 2009 (GB) 0917690.0

(51) Int. Cl. H01Q 9/36; H01Q 21/00

(52) U.S. Cl. 343/731; 343/893

(57) ABSTRACT

A stacked disk loaded antenna (80) that uses a dual double tuned impedance matching networks to broadband match the radiation resistance to a 50Ω port. Using two antenna elements (31, 64) in a stacked construction results in the antenna effectively combining the bandwidth ranges of both the antenna elements and removes the requirement for external tuning, which will add weight to an antenna structure. The stacked antenna system can be employed within communication systems operating within the HF and UHF bands.

### TECHNICAL FIELD OF THE INVENTION

This invention relates to an antenna arrangement and particularly to a compact antenna and more particularly to a compact antenna suitable for use in wideband applications.

### BACKGROUND TO THE INVENTION

In recent years there has been significant interest in the development of compact, but efficient antennas, capable of operating across a wide bandwidth or at multiple frequencies. In particular, there is a requirement for an antenna having the following electrical and physical characteristics; compact, lightweight, robust, low cost and a wideband frequency response.

The capability to extend the frequency response further to provide an ultra-wideband response is particularly desirable.

Ultra-wideband (UWB) is a wireless radio technology which allows the user to transmit large amounts of data across a very wide range of frequencies. Ultra-wideband systems have applications in many fields such as high-speed, short range, wireless communication; radar and geolocation systems; imaging; and medical systems.

A bandwidth covering at least the frequency range 20 MHz-6 GHz would allow coverage of traditional HF and UHF bands while extending operation to the higher frequency Wireless Local Area Network (WLAN) and future 3G/4G (3-5 GHz) spectrums. However, achieving an electrically small antenna that is reasonably radiation efficient and operates over wide bandwidths is challenging and various solutions which claim to optimise different combinations of properties have been proposed. Wide bandwidths can be achieved by clustering a number of different antennas such as combinations of wire, disk cone and bow-tie antennas however this requires costly and bulky feed networks. Alternatively several monopoles of varying heights above a ground plane have been used but this solution does not provide an instantaneous capability, instead the monopoles work in a stepped time sequence when transmitting and receiving data.

Particular applications such as detection and measurement systems dictate additional requirements such as reduced return losses and omni directional radiation patterns. For these applications in particular it is necessary to focus on monopole and dipole antennas and the present invention is a development of the monopole antenna.

It is known that the performance of a traditional monopole antenna can be improved by “top-loading”. This refers to the addition of capacitance at the free end of the antenna element and is usually achieved by the addition of a disk or “tophat”. The effect of the added capacitance is to increase the vertical current moment and hence radiation efficiency of the antenna; to decrease the feed point reactance which decreases the feed point voltage and to decrease the Q factor which results in increased bandwidth capability. One such top loaded antenna that has been used significantly for wide-band applications is the Goubau antenna (U.S. Pat. No. 3,967,276). The Goubau antenna is a low profile (≈0.15λ) top-loaded multi-element monopole with two driven and two not driven elements exhibiting nearly an octave bandwidth. By splitting the monopole cap or table-top into sections Goubau introduces more capacitance and series inductive loops into the antenna circuit topology resulting in a double tuned “resonate tank” circuit. In so doing Goubau is able to reduce the physical height of the antenna while maintaining or enhancing the antenna radiation resistance. The Goubau antenna uses either a single or balanced feed, providing a performance of VSWR ≦1.5:1 over a 2:1 bandwidth (450 MHz-850 MHz). Foltz (Closed-Form Lumped Element Models for Folded, Disk-Loaded Monopoles IEEE 2002) provided impedance bandwidth enhancement to the Goubau antenna by using a wideband rhombic feed.

### SUMMARY OF THE INVENTION

It is an object of the present invention to provide an antenna arrangement which provides a significant improvement in the impedance bandwidth of a compact wideband antenna element.

Accordingly the present invention provides an antenna arrangement comprising a ground plane, a coaxial feed and a first antenna element, wherein the first antenna element comprises, a top loaded structure, an elongate transverse electromagnetic wave (TEM) transmission line at least a portion of which is positioned at a predetermined distance from the ground plane and a conductive core extending from the coaxial feed and electrically connected to the TEM transmission line.

The adoption of a coaxial to TEM transmission line connection where a portion of the transmission line is a predetermined distance from the ground plane permits increased matching bandwidth because the connection is inherently wideband to wideband and the distance can be adjusted to help impedance matching. The term “coaxial” is used to mean a shielded electrical cable constructed with precise conductor dimensions and spacing in order to function efficiently as a radio frequency transmission line. The coaxial is capable of propagating a TEM wave, allowing a RF bandwidth in principle of up to 18 GHz to be propagated along the cable. A TEM transmission line is intended to include a coaxial, balanced transmission line or other such TEM or quasi-TEM propagation devices known in the art. Any abrupt change in the relative dimensions causes increased reflection, reducing the quality of the transmitted power. For this reason the preferred embodiment uses a coaxial to coaxial electrical connection.

To reduce the area taken up by the TEM transmission line whilst maintaining the length, at least the end portions of the transmission line can be extended by a variety of means such as meandering or spiraling without increasing the physical area taken up by the antenna. The ends of the transmission line or another point chosen by a person skilled in the art can be connected to a resistive load. The resistive load is connected across the coaxial line and ground plane. The resistance device can be altered in value to allow impedance matching with the coaxial feed.

Top loading the antenna element increases the capacitance effect of the antenna so that the physical structure may be reduced in height. The top loaded structure can be varied in its shape and construction and can be made from any metallic material. The preferred embodiment uses a large “top hat” disc structure. The disc can also be sub divided into a number of discrete sections, like a Goubau top loaded antenna with spacing between each section to further improve the capacitance of the antenna arrangement and hence reduce the physical height of the antenna further.

The introduction of a second antenna element arranged in stacked relationship to the first offers the combined benefit of both antenna elements. The second antenna element can be stacked internally or externally of the first antenna arrangement. Using both antenna elements in a stacked construction, results in the antenna effectively combining the bandwidth ranges of both the antenna elements and removes the requirement for external tuning, which will add weight to an antenna structure. The second antenna element could comprise an extension of the conductive core from the coaxial feed beyond its connection to the TEM transmission line. However, by utilising an UWB antenna element as the second antenna element a UWB matched frequency response can be provided. In this embodiment the transmission line is used to efficiently excite the low frequency radiator (top loaded structure) while the second antenna element is used to efficiently excite the high frequency spectrum of its own top loaded structure. Exciting the antenna in this way achieves a bandwidth of several decades e.g. 70:1 (100 MHz to 7 GHz) with an impedance match VSWR of 3.5:1 (approximately 5 dB). An example of a suitable second antenna uses the conductive core from the coaxial feed extending through the TEM transmission line (coaxial) as the core of an aperture connected antenna element. A cylindrical conductive case surrounding the conductive core and a top loaded disc surrounding the conductive core being configured as a shorted coaxial section can be utilised to increase the capacitance performance of the second antenna element. Furthermore the use of a first dielectric material positioned between the cylindrical conductive case and the first antenna element and also a second dielectric material positioned within the cylindrical conductive case can further increase capacitance effect and improve the Q factor of the second antenna element resulting in increased bandwidth capability.

In the simplest form of antenna construction the first and second dielectric material used can be air. The dielectric value of a material depends on its permittivity. The choice of material used relates to its higher or lower capacitive effect. Increasing the permittivity of the second dielectric material enhances the performance of the second antenna element and hence the antenna arrangement. One particular embodiment of the second antenna element uses air as the first dielectric material and polytetrafluoroethylene (PTFE) as the second. A person skilled in the art will appreciate that other combinations of dielectric materials can be used.

Ensuring there is a gap between the cylindrical conductive case and the TEM transmission line and using air for the first dielectric material allows the increase of the capacitance effect of the second antenna element and therefore the bandwidth capability. Also by adjusting the gaps between the top loaded structure and the end of the conductive core and also between the cylindrical conductive case and the TEM transmission line can allow the second antenna element to be fine tuned to ensure the ideal impedance matching bandwidth is obtained. The second antenna element is more fully described in co-pending British patent application number GB ______ the contents of which are hereby incorporated by reference (the agents internal reference is P1520).

Furthermore encasing the antenna arrangement in a dielectric material can offer further reductions in the Q factor and therefore gains in bandwidth. Also the use of a solid dielectric provides structural support and will enhance robustness.

The antenna arrangement can further include a plurality of radial fins which act as spatial polarisation filters. The fins may comprise fast or slow surface wave structures to act as high impedance surfaces. Use of fins reduces the need to surround an antenna with a solid dielectric material. Furthermore the fins act as spatial polarisation filters to aid isolation and directionality of signals. By providing an array, particularly a ring shaped array of such antenna arrangements a direction finding capability can be provided.

By providing a plurality of antenna arrangements of pre-selected differing heights the antenna designer can multiply the bandwidth capability if operated in a stepped sequence.

A wide band Electromagnetic Band Gap (EBG) surface can be assembled by grounding a plurality of antenna arrangements on a metal substrate. In this application the antenna arrangements are scaled to an appropriate sub-wavelength λ/10-λ/20 dimension and arranged into a two-dimensional scattering surface, in order to scatter an incident field. Such an electromagnetic band-gap surface exhibits enhanced bandwidth, compared with known EBG surfaces. Furthermore, a number of two-dimensional surfaces may be stacked to form a three dimensional lattice, the electromagnetic band gap of each surface being arranged to be non-identical but overlapping, thus extending the EBG frequency range of operation.

### BRIEF DESCRIPTION OF THE DRAWINGS

The invention will now be described, by way of example, with reference to the accompanying drawings, in which:

FIG. 1a shows a diagram of a Goubau antenna with unbalanced feed excitation cross and FIG. 1b shows a balanced feed excitation variant.

FIG. 2 shows published return loss bandwidth response or VSWR for the Goubau Antenna shown in FIG. 1b.

FIG. 3 shows a cross sectional illustration of an antenna arrangement in accordance with the invention;

FIG. 4 shows a cross sectional illustration of an antenna arrangement in accordance with the invention and FIG. 5 shows a cross section illustration of a preferred embodiment of antenna arrangement in accordance with the invention.

FIG. 6 shows a cross sectional illustration of an antenna arrangement in accordance with the invention using a balanced strip line for the first antenna element.

FIG. 7 shows the measured and simulated (using HFSS v10) return loss of the preferred embodiment of the antenna arrangement of FIG. 5

FIG. 8 a to h show simulated E_{θ} radiation patterns covering the frequency spectrum between 0.25 and 6.0 GHz.

FIG. 9 shows the simulated antenna gain of the preferred embodiment of the antenna arrangement of FIG. 5.

FIG. 10a shows the physical and FIG. 10b the circuit representation of the preferred embodiment of the antenna arrangement of FIG. 5.

FIG. 11 shows a comparison of the circuit model response with measured return loss of the preferred embodiment of the antenna arrangement of FIG. 5.

### DETAILED DESCRIPTION

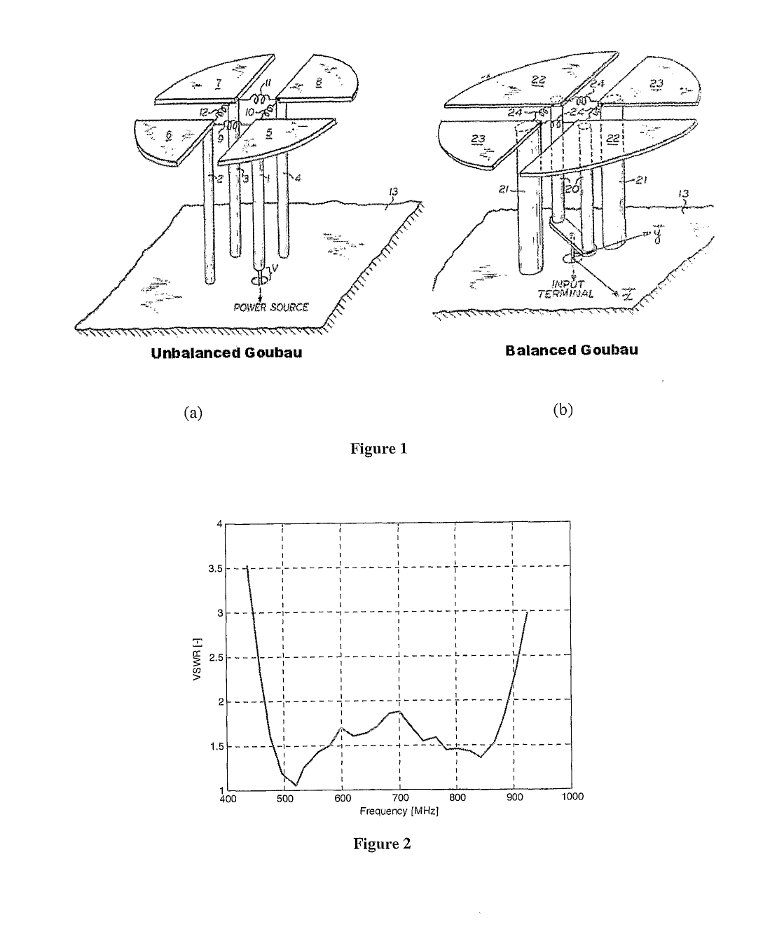

FIG. 1a shows a diagram of the Goubau antenna with unbalanced feed excitation cross and FIG. 1b shows a balanced feed excitation variant. By splitting the top loaded disk into sections Goubau introduces more capacitance and series inductive loops into the antenna circuit topology resulting in a double tuned “resonate tank” circuit. In so doing Goubau is able to reduce the physical height of the antenna while maintaining or enhancing the antenna radiation resistance. FIG. 2 illustrates the performance of the Goubau antenna having a return loss bandwidth response or VSWR ≦1.5:1 over a 2:1 band width (450 MHz-850 MHz).

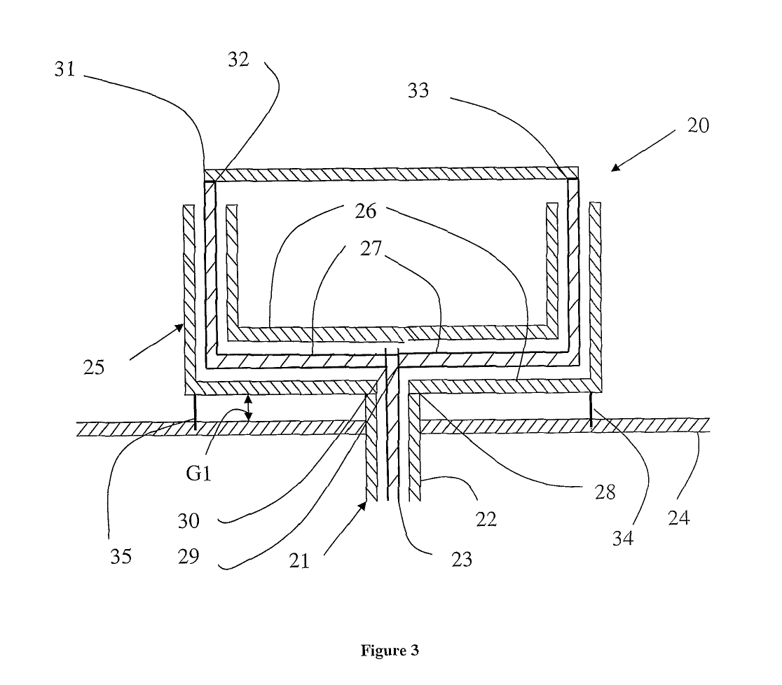

FIG. 3 illustrates a cross section schematic representation of an antenna arrangement 20 in accordance with the invention. In this arrangement a coaxial feed 21 comprises an outer case 22 and an inner wire 23. The outer case 22 is connected to a ground plane 24. A second coaxial 25 is provided comprising an outer case 26 and the inner wire 27. The inner wire 23 is electrically connected 29 & 30 to the inner wire 27 of the second coaxial 25. The two coaxial outer cases 22 & 26 are electrically connected 28. The outer ease 26 is positioned at a gap G1 above the ground plane 24. A top loaded plate 31 is electrically connected 32 & 33 to the inner wire 27. The second coaxial 25 is electrically connected 34 & 35 to the ground plane 24. The electrical connection 34 & 35 can be made via a resistive load.

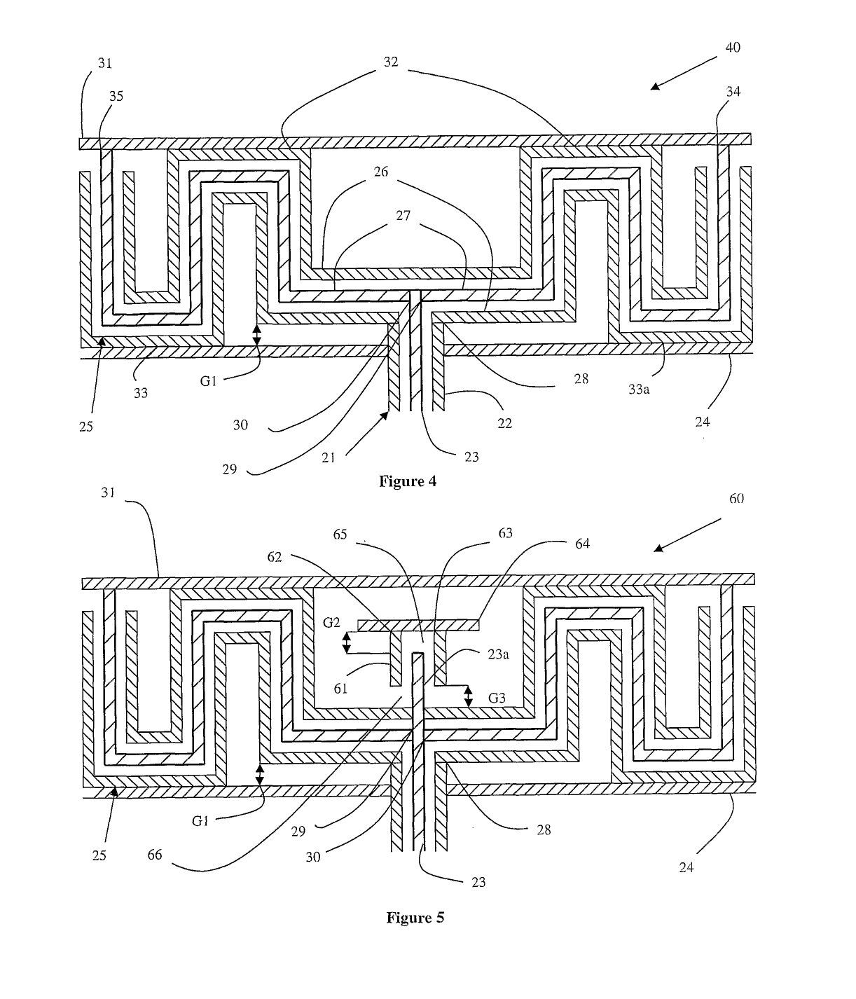

FIG. 4 illustrates a cross section schematic representation of an antenna arrangement 40 in accordance with the invention. In this arrangement a coaxial feed 21 comprises an outer case 22 and an inner wire 23. The outer case 22 is connected to a ground plane 24. A second coaxial 25 is provided comprising an outer case 26 and the inner wire 27. The inner wire 23 is electrically connected 29 & 30 to the inner wire 27 of the second coaxial 25. The two coaxial outer cases 22 & 26 are electrically connected 28. The outer case 26 is positioned at a gap G1 above the ground plane 24. A top loaded plate 31 is electrically connected 32 to the outer case 26 and also electrically connected 34 & 35 to the inner wire 27. The ends of the second coaxial 25 are meandered and are electrically connected 33 & 33a to the ground plane 24.

FIG. 5 illustrates a cross section schematic representation of a preferred embodiment of antenna arrangement 60 in accordance with the invention. The embodiment is a development of that shown in FIG. 4 The common features of FIG. 4, the inner wire 23, the ground plane 24, top loaded plate 31 and second coaxial 25 are indicated. Additionally the inner wire 23 extends above the ground plane 24 and through outer case 26. The inner wire 23 acts as a conductive core 23a which is located concentrically within a cylindrical conductive case 61. The cylindrical conductive case 61 is configured as a shorted coaxial section and is electrically connected 62 & 63 to a top loaded disk 64. A dielectric material 65 is located within the inner volume of the cylindrical conductive case 61. In this embodiment the dielectric material 65 is PTFE. A gap G2 is provided between the top loaded disk 64 and the end of the conductive core 23a. A gap G3 is provided between the cylindrical conductive case 61 and the second coaxial 25. A dielectric material 66 is provided between the cylindrical conductive case 61 and the second coaxial 25. In this embodiment the dielectric material 66 is air.

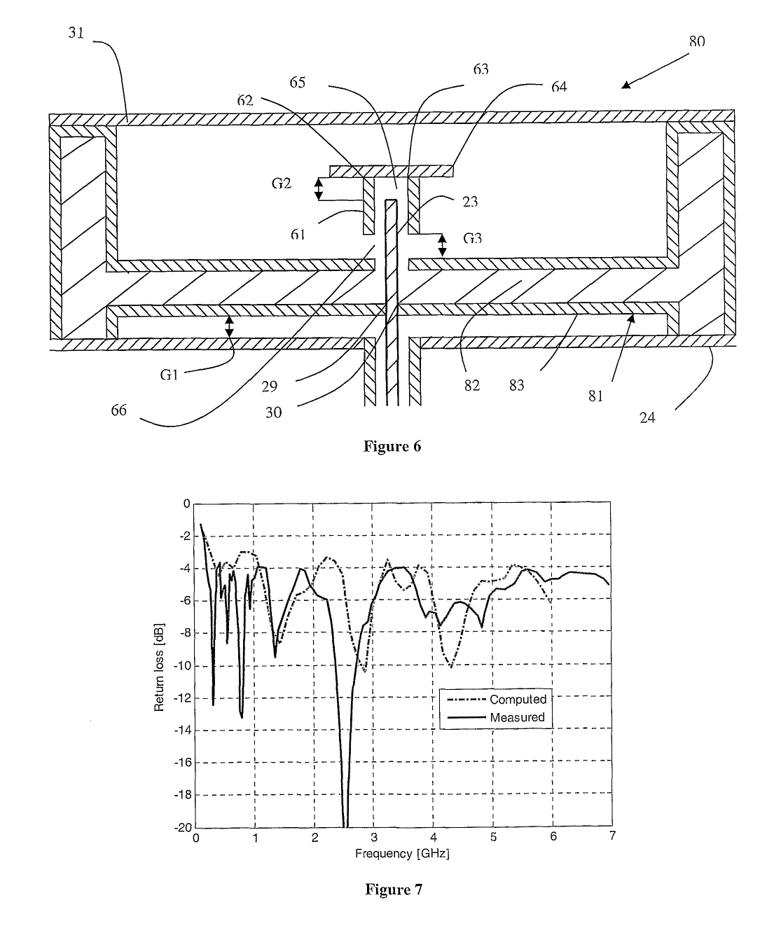

FIG. 6 illustrates a cross sectional schematic representation of an embodiment 80 which is a variation of FIG. 5 using a balanced strip line 81. This embodiment was built and measured. The common features of FIG. 5, the inner wire 23, the ground plane 24, top loaded plate 31 and the top loaded disk 64 are indicated. The balanced strip line 81 comprises a PCB inner 82 and a copper outer casing 83. The balanced strip line 81 is electrically connected 29 & 30 to the inner wire 23 and is also electrically connected to the ground plane 24 and top loaded plate 31. For experimental measurements the following dimensions were used for the antenna arrangement. The top loaded plate 31 (low frequency) has a height of 6.6 cm above the ground plane and a disk diameter of 19 cm. The top loaded plate 31 is etched on PCB FR4 (∈ᵣ=4.5 and tan δ=0.002 @ 1 GHz). FR4 PCB board is used for construction of all the antenna components described. The inner wire 23 extends a height of 5.9 mm above the ground plane. The end of the launcher extends into a PTFE which is surrounded by a top loaded cylindrical conductive case 61, configured as a shorted coaxial section. The launcher is also connected to the balanced “common rail” transmission line 81 which is supported by and electrically connected to two vertical strip lines that connect to the top loaded plate 31. These strip elements are 5.8×6.5 mm wide and can be thought of as planar sheets of the unfolded cylindrical elements in the original Goubau design. The “common rail” transmission line 81 transports a quasi-TEM wave that is supported between the ground plane and the open strip line. The strip line is constructed from FR4 (thickness t=1.5 mm) and is 16.8 cm long, its electrical length controls the primary lower frequency λ/4 resonance. Two vertical undriven dielectric posts or strips (not shown) are also positioned symmetrically around the top loaded plate 31 to provide more mechanical support. Gap G1 is important for the lower cut off frequency response. If the gap is too low, the current is choked and if the gap is too high, then very little current flows onto the ground plane.

FIG. 7 shows the measured impedance bandwidth simulated and measured over a 7 GHz bandwidth. The measurement shows a return loss of −4.6 dB across the band. The low frequency double resonance due to the first antenna element at 0.77 and 1.37 GHz is present along with the high frequency double resonance due to the second antenna element at 2.5 GHz and 4.8 GHz. The simulated results are in reasonable agreement with measured from 1-6 GHz; below 1 GHz the simulated results deviate from measured not picking up the 0.77 GHz resonance. It should be noted that the addition of loss to the feed network would further improve the input impedance but with some reduction in radiation efficiency.

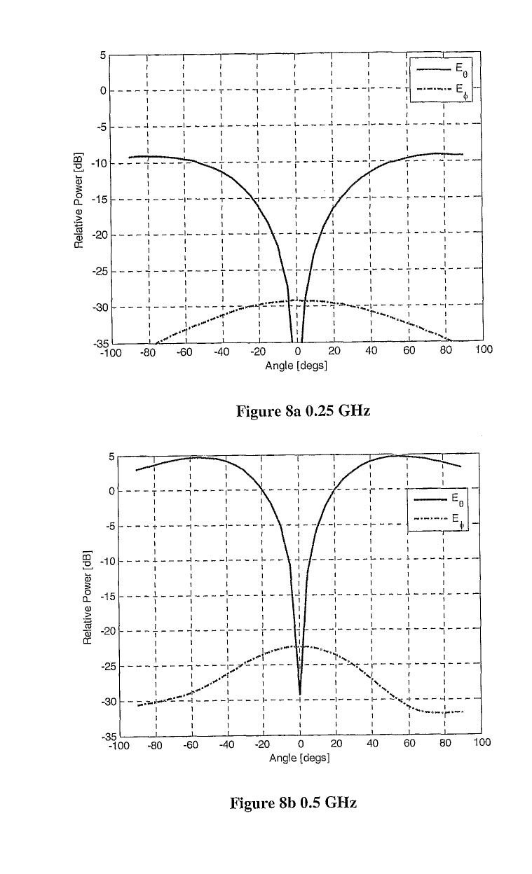

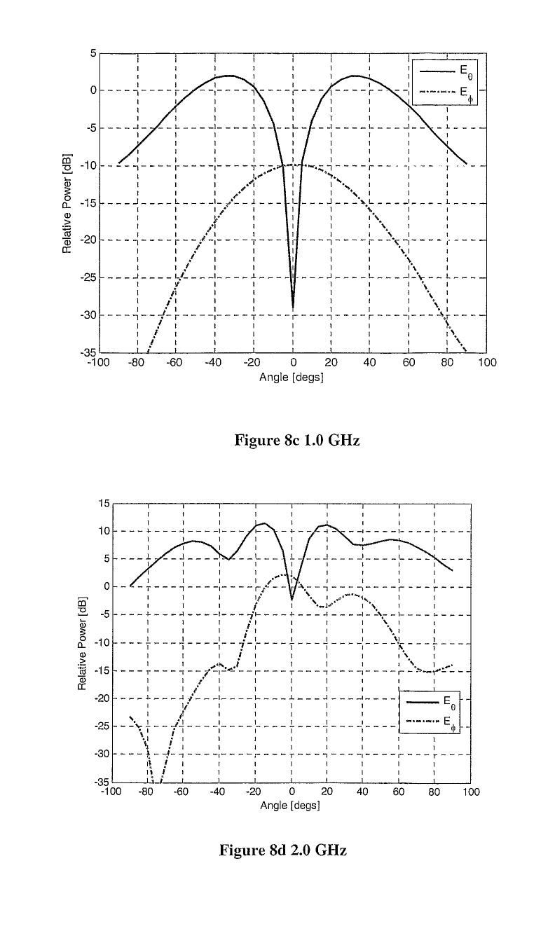

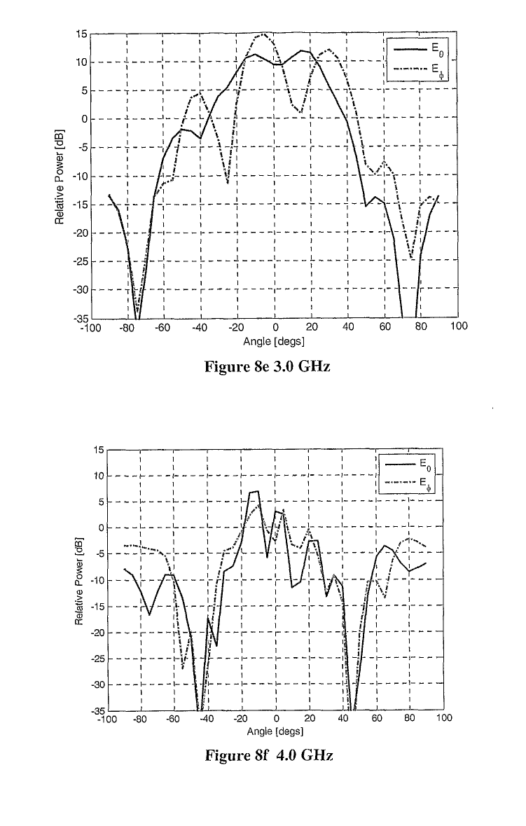

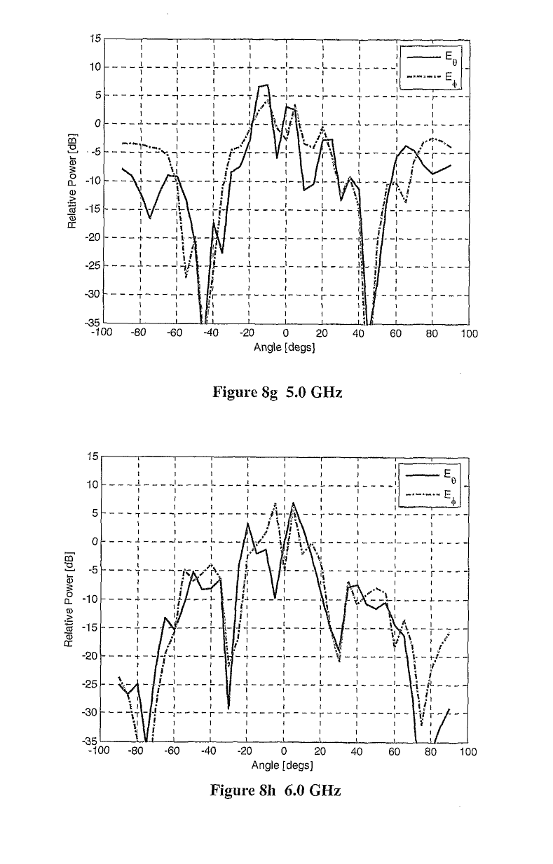

FIG. 8 a to h show a selection of simulated antenna radiation patterns from 0.25-6.0 GHz. The field pattern shapes are dipole like with low gain, as would be expected. At higher frequencies 2.5-6.0 GHz cross-polarisation levels appear similar in magnitude to co-polar. It should be noted that the second antenna element plays a crucial role in the antenna arrangement by providing an additional capacitive coupling mechanism to the top loaded plate. Numerical experiments indicated that inclusion of the second antenna element increases the resonance bandwidth and increases the radiation resistance as compared with first antenna element without the second antenna element integrated. If cross-polar fields are critical to antenna performance then the limit for the first antenna element is the pattern bandwidth and not the matching bandwidth. Those practised in the art of compact wideband antenna design will appreciate the design novelty in the integration of matching networks and the resultant performance of the antenna arrangement.

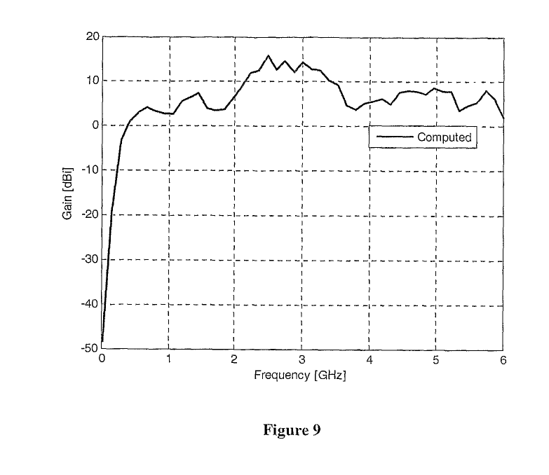

FIG. 9 illustrates the simulated gain of antenna arrangement as shown in FIG. 5. The computed gain is likely to deviate by ±1 dB, however the general trends in gain versus frequency is considered correct. Below about 400 MHz the gain is negative and monotonically decreases rapidly with decreasing frequency. Above 1 GHz the gain oscillates around 3-5 dBi. Radiation efficiency was computed using HFSS and indicated radiation efficiency ≧50%. Efficiency computation is notoriously difficult and this result can only be considered approximately. Therefore measurements of radiation efficiency were undertaken using the Wheeler Cap technique. This measurement is accomplished by placing the antenna within a sealed shielded metal enclosure that shorts out far-field radiation but does not significantly perturb the near-field. A “metal cap” was constructed from aluminium to behave as a short section of circular waveguide. The cylindrical diameter was 50 cm and height 30 cm. This provided a principal modal cut-off frequency f_{c} at,

$${f}_{c} = \frac{2.405}{2 π r \sqrt{{μ}_{o} {ɛ}_{o}}} = 458.77 MHz \qquad ( 1 )$$

The low cut-off frequency only permitted examination of radiation efficiency below 450 MHz.

The antenna efficiency can be calculated using (2), where R_{FreeSpace} is the input resistance without the metal cap on and R_{Cap} is the input resistance with the metal cap placed over the antenna:

$$η = \frac{{R}_{FreeSpace} - {R}_{Cap}}{{R}_{FreeSpace}} \times 100 \% \qquad ( 2 )$$

Radiation efficiency was assessed over several frequencies. Table 1 indicates some of the results for the calculation of measured radiation efficiency below 450 MHz.

TABLE 1
Measured radiation efficiency of antenna arrangement in FIG. 4b

| Frequency | Radiation |
|---|---|
| (MHz) | efficiency η |
| 100 | 35% |
| 200 | 51% |
| 360 | 48% |

The calculated radiation efficiency results were better than 30% with a measurement error of ±2%.

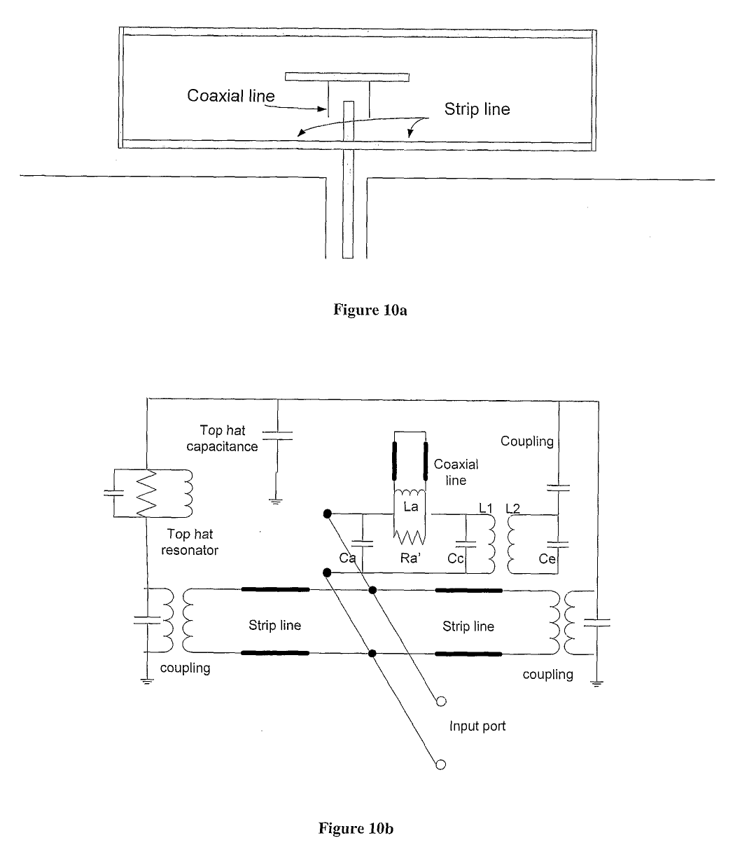

FIG. 10a shows the physical layout and FIG. 10b the equivalent circuit representation for antenna arrangement shown in FIG. 5. The top loaded plate is fed using a single coaxial connection which distributes the RF signal between two distributed elements; which may be coaxial or strip line and also feeds the second antenna element. The principle of matching was to overlap a low frequency double tuned response (top loaded plate of the first antenna element with the higher frequency double tuned response (top loaded disk of the second antenna element); using this technique a multi-decade impedance match and radiation pattern bandwidth was achieved. The matching network is integral with the antenna.

Equations (3)-(8) were used to arrive at initial values of reactive elements for the large disk while the transmission lines and the first antenna element were added to the circuit topology.

Ca=∈₀πr²/h (3)

Ca is the internal capacitance of the simple disk loaded monopole.

$$Ce = {ɛ}_{0} r [ 8 + \frac{2}{3} ln ( \frac{1 + 0.8 {( r / h )}^{2} + {( 0.31 r / h )}^{4}}{1 + 0.9 ( r / h )} ) ] \qquad ( 4 )$$

Ce is the external fringing field capacitance of the disk loaded monopole,

Rr=40(2πh/λ)² (5)

Where Rr is the radiation resistance in the axial wire of a small antenna.

G=ω²(Ce+Ca)²Rr (6)

G is a parallel conductance term that takes account of the frequency dependence of Rr and

$$Ra = 60 \frac{h}{r} \qquad ( 7 )$$

Ra is the equivalent aperture loading resistance.

$$La = \frac{\sqrt{GRa}}{{ω}^{2} Ce} \qquad ( 8 )$$

While La is the value of inductance across the resistance to give the appropriate frequency variation. The coaxial element was modelled as a distributed short circuited coaxial component since its equivalent frequency variation would be more exactly followed.

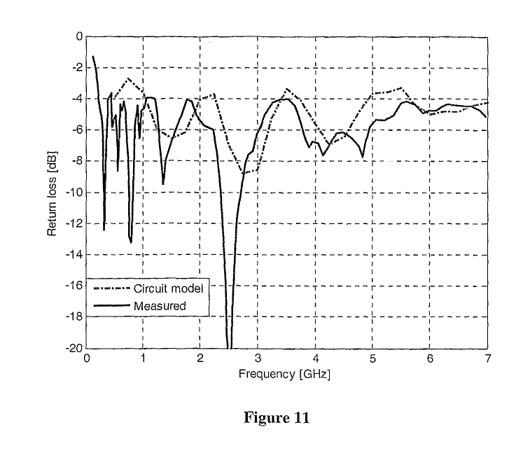

The circuit was simulated using the commercial software Ansoft® Designer (available from Ansoft). The top-hat “tank circuit” LCR values were calculated using the expressions for internal and external capacitance with the physical dimensions for the larger disk. The complete circuit was modelled in the commercial Ansoft Designer software. FIG. 11 shows the result for one of the simulations versus experimental measurement. The agreement between the two is considered good given some values had to be estimated.

### SUMMARY

The present invention is a stacked disk loaded antenna that uses a dual double tuned impedance matching networks to broadband match the radiation resistance to a 50Ω port. The match is implemented by two inter-connected double tuned networks one low frequency transformer the other a high frequency transformer that are arranged to overlap in frequency bandwidth. The low frequency network employs a balanced stripline (or coaxial feed) that impedance transforms up to the large low frequency disk. Another higher frequency disk is stacked below the top disk parasitically coupling to the large disk. Arranged in this way the new reactive matching network does not require any external tuning, and extends the frequency impedance bandwidth (3.5:1 VSWR) over 70:1 bandwidth coverage from 100 MHz to 7.0 GHz. The antenna radiation pattern bandwidth is 20:1 (100 MHz-2.0 GHz), dipole like, with a maximum on the horizontal plane and cross-polar levels below ≦20 dB. If cross-polar levels are non-critical then the 70:1 bandwidth may be used but some side-lobe structure is present. Radiation efficiency values are good and suitable for both transmit and receive applications.

Whilst the current design has been optimised for maximum bandwidth it is accepted that a better quality of impedance match is possible over a narrower bandwidth and this aspect is particularly important at the low frequency end of the spectrum.

1. An antenna arrangement comprising a ground plane, a coaxial feed and a first antenna element, wherein the first antenna element comprises, a top loaded structure, an elongate TEM transmission line at least a portion of which is positioned at a predetermined distance from the ground plane and a conductive core extending from the coaxial feed and electrically connected to the TEM transmission line.

2. An antenna arrangement according to claim 1 wherein the TEM transmission line comprises a coaxial cable.

3. An antenna arrangement according to claim 1 wherein the TEM transmission line comprises a balanced transmission line.

4. An antenna arrangement according to claim 1 wherein at least the end portions of the TEM transmission line are meandered.

5. An antenna arrangement according to claim 1 wherein the TEM transmission line is connected to the ground plane via a resistive load.

6. An antenna arrangement according to claim 1 wherein the top loaded structure is a plate.

7. An antenna arrangement according to claim 6 wherein the top loaded plate is sub divided into a plurality of discrete sections.

8. An antenna arrangement according to claim 1 wherein the arrangement further comprises a second antenna element arranged in stacked relationship to the first antenna element.

9. An antenna arrangement according to claim 8 wherein the second antenna element is capable of an ultra wide-band response.

10. An antenna arrangement according to claim 9 wherein the second antenna element comprises:
a cylindrical conductive case isolated from the TEM transmission line by a first dielectric material,
a second dielectric material contained within the cylindrical conductive case;
the conductive core extending beyond the TEM transmission line and through the first dielectric material and into the second dielectric material; and
a top loaded structure electrically connected to the cylindrical conductive case and electrically insulated from the conductive core,
the second antenna element being configured as a shorted coaxial section.

11. An antenna arrangement according to claim 10 encased in a dielectric material.

12. An antenna arrangement according to claim 10 wherein the antenna arrangement further comprises a plurality of fins positioned radially with respect to the antenna arrangement.

13. An antenna arrangement according to claim 12 wherein the fins comprise High Impedance Surfaces.

14. An antenna array comprising a plurality of antenna arrangements according to claim 10.

15. An antenna array according to claim 14 wherein the plurality of antenna arrangements comprise antenna elements of a plurality of heights.

16. An antenna array according to claim 14 wherein the antenna arrangements are arranged in a linear configuration.

17. An antenna array according to claim 14 wherein the antenna arrangements are arranged in a ring shaped configuration.

18. An antenna array according to claim 14 wherein the plurality of antenna arrangements are grounded in a two-dimensional scattering array surface in order to provide an Electromagnetic Band Gap surface.

19. (canceled)
